(19) United States
(12) Patent Application Publication
(10) Pub. No.: US 2008/0047793 A1
(43) Pub. Date: Feb. 28, 2008

(54) Dropper

(76) Inventors: Peter R. Shrubsall, Devon (GB); Nick Ruston, Plymouth (GB); Richard G. Bointon, Devon (GB); Alan Sleith, Surrey (GB)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/569,558

(22) PCT Filed: Jul. 13, 2005
(86) PCT No.: PCT/GB05/02790

§ 371 Date: Jul. 17, 2007

(30) Foreign Application Priority Data
Jul. 16, 2004 (GB) 0416008.1

(51) Int. Cl. B60M 1/23

(52) U.S. Cl. 191/40

(57) ABSTRACT

The present invention relates to a dropper (1) for use in connecting a conductor (5) and a catenary wire (6) in an overhead electric traction system comprising: a conductor clamp (2) for connecting the dropper (1) to the conductor (5), which comprises a moulded clamp body (7) that snaps onto the conductor (5); a dropper cord (3) connected to the clamp body (7) at the end opposite to that connecting with the conductor (5); and a catenary hook (4) for connecting the dropper cord (3) to the catenary wire (6), wherein the dropper cord (3) is flexible such that the application of a substantially vertically upwards force exerted by the conductor (5) to the conductor end of the dropper cord (3) causes the dropper cord (3) to bend thereby to prevent any upwards movement of the catenary wire (6).

The present invention relates to a dropper for use with overhead electric traction systems.

In overhead traction systems used in conjunction with electric trains, one or more conductors are suspended from a catenary wire above a train. Each conductor typically supplies 25 kilovolts (kV) and 3000 amperes (A) to a train via a pantograph attached to its roof, the pantograph being a spring-loaded damped mass with an aerodynamic design to “fly” with minimal disturbance at a reasonably constant height above the rails. A dropper is used to connect the conductor to the catenary wire and to hold the conductor at a fixed height above the rails. There are, however, several problems associated with the semi-rigid droppers that are currently being used for this purpose, the more serious of which will be highlighted herebelow.

During the passage of a pantograph along the length of the conductor, a mechanical uplift of approximately 10 mm is imparted to the conductor. With the droppers that are currently in use, this uplift is transferred to the catenary wire via the dropper, which acts as a compressive strut. The effect of this uplift is to create a travelling wave ahead of the pantograph resulting in variable contact between the pantograph and conductor and registration of this inconsistency by the pantograph, which leads to arcing and the emission of electromagnetic radiation, and hence also disruption to radio signalling equipment alongside the railway track. This problem is worsened at faster train speeds and is one of the main causes of the failure of current installations.

Furthermore, installation of the droppers is costly, time-consuming, and requires high levels of manpower and sophisticated equipment. This is evident from the installation method used, which involves the following steps: (i) surveying the line with a laser; (ii) measuring the span between the conductor and catenary at each point along their lengths to be connected via a dropper; (iii) storing the dropper lengths in a database as a function of their position on the conductor and catenary, respectively; (iv) manufacturing the droppers on or offsite according to the data stored in step (iii); and (v) installing the dropper by fitting its top clamp to the catenary, hanging the dropper and then attaching the conductor to the bottom of the dropper. As can be appreciated, any error made in steps (i) and/or (ii) would probably not come to light before attempting to fit the droppers, and would end with the undesirable need to conduct the installation process afresh.

More seriously, currently available stainless steel droppers are designed such that they transfer the vertical pull to which the conductor may be subjected, due to ice, wind or vegetation effects, to the catenary and support structure. Thus, the likelihood of the catenary and support structure being pulled down by the passage of a pantograph on the conductor increases, and, if this occurs, it causes significant damage to the support structure, pantograph and, also possibly, off-track radio-signalling equipment. Clearly, replacement of any components of the system and/or repair of any damage requires the closure of the affected line for significant periods of time, not to mention investment of manpower, time and money.

Accordingly, it is desirable to provide a dropper that: (i) absorbs any excessive vertical forces exerted by the pantograph on the conductor, (ii) can be installed with ease and minimal investment of manpower, time and money, and that is less subject to human-error than known installation methods, and (iii) provides a form of damage control in that it fails before excessive vertical forces are transferred to the catenary and/or conductor, thus reducing the possibility of significant damage to the traction system.

According to an embodiment of the present invention, there is provided a dropper for use in connecting a conductor and a catenary wire in an overhead electric traction system comprising: a conductor clamp for connecting the dropper to the conductor, which comprises a moulded clamp body that snaps onto the conductor; a dropper cord connected to the clamp body at the end opposite to that connecting with the conductor; and connection means for connecting the dropper to the catenary wire, wherein the dropper cord is flexible such that the application of a substantially vertically upwards force exerted by the conductor to the conductor end of the dropper cord causes the dropper cord to bend, thereby to prevent any upwards movement of the catenary wire.

By having a flexible cord, the dropper absorbs any uplift imparted to the overhead conductor and/or catenary when a pantograph travels the length of the conductor. Thus, the possibility of a travelling wave being set up before the path of the pantograph, which would cause the undesirable scenario of arcing and/or damage to electrical equipment, is reduced.

Desirably, the dropper cord bends by at least 10% of its length.

Since the cord is able to bend by at least 10% of its length (the reasons for which are discussed later), it is clear that, for example a 100 mm length of cord would be able to absorb the 10 mm uplift typically imparted to the conductor by the passage of a pantograph along the conductor length by bending by the same amount. Thus, the possibility of serious damage to the catenary and/or conductor is reduced.

Preferably, the dropper cord is made of poly ether ether ketone (PEEK™) or a liquid crystal polymer such as Vectran™.

The materials PEEK™ or Vectran™ have been chosen carefully so that the dropper cord is able to meet the flexibility characteristics (as discussed in detail later) that distinguish a dropper embodying the present invention from other known droppers. These materials in combination with the overall design of the dropper ensure that the conductor can be held in the correct position for several years without major degradation.

Preferably, the clamp body further comprises jaws on the interior of its section that snaps onto the conductor.

The conductor clamp is secured to the conductor via the clamp jaws, which snap onto the conductor. In order to further ensure that they securely lock together, the inner surfaces of the clamp jaws are designed to match the outer profile of the conductor.

Desirably, a load bearing element is provided on the outer body of the conductor clamp, for example in the form of a load ring provided on a groove formed on the conductor clamp body. Preferably, the load bearing element is made of stainless steel.

In an embodiment of the present invention, a continuous wire, welded load ring made of stainless steel is located in a groove formed on the lower end of the outer surface of the clamp body. When the dropper is in use, the load of the conductor is transferred to the dropper cord via the clamp body. Due to the manner of contact between the conductor and the clamp body, and the forces exerted on the conductor clamp by the conductor when the dropper is in use, the clamp body would normally be forced open but is prevented from doing so by the load ring. However, the strength of the load ring is chosen such that, if the conductor exerts an excessive vertical pull that approaches a maximum load that the clamp body has been designed to withstand, the load ring breaks first and releases the conductor, dropping it onto the track. In this way, the load ring provides a first mode of damage control since the excessive vertical forces that the conductor clamp is subjected to are not transferred to the catenary and/or support structure. Furthermore, damage is limited to easily replaceable items both in terms of skill, manpower and costs.

Preferably, the load bearing element is designed to fail when the conductor clamp is subjected to a first predetermined load, for example a substantially vertically downwards force of at least 1200N.

Appropriate selection of the material and dimensions of the load bearing element allows the breaking load to be selected.

Preferably, the conductor clamp further comprises a ferrule for containing the dropper cord, which is made of aluminium, for example.

The dropper cord is threaded via a hole in the upper end of the conductor clamp into the ferrule wherein it is looped and held compactly.

Desirably, an elastomeric sleeve is provided over the conductor clamp and the load bearing element.

The sleeve protects the conductor clamp and the load bearing element from adverse environmental conditions such as rain, snow, contamination, etc., thus increasing their life expectancy and resilience. Importantly, the sleeve inhibits the ingress of water, which may cause galvanic corrosion between the ferrule and the copper conductor or load bearing element.

Desirably, the elastomeric sleeve is also provided over the dropper cord.

The elastomer can be provided as a continuous sleeve or impregnated onto the surface of the dropper cord whilst ensuring that there are no voids in order to deter moisture ingress into the cord.

Whilst any suitable material can be used for the elastomeric sleeve, silicone is preferably used in an embodiment of the present invention.

The connection means desirably comprise a catenary hook for connecting the dropper cord to the catenary wire.

Preferably, at least one spike is provided on the inner surface of the catenary hook. Spikes moulded on the inner surface of the catenary hook are designed to fit into the interstices of the outer wire filaments of the catenary wire. This inhibits relative axial motion between the hook and the catenary wire due to any twist in the wire.

Desirably, a wire hook is contained in a bearing cylinder moulded in the top of the catenary hook. The dimensions of the wire hook are chosen such that the underside of the catenary wire is held firmly against the inside of the hook moulding, thus also reducing the probability of the catenary wire twisting.

Alternatively, the connection means may comprise a first portion for attaching the dropper to the catenary wire and a second portion, joined to the first portion, for holding the dropper cord. Preferably, the first portion is joined to the second portion by means of a stainless steel pin.

The first portion of the connection means desirably comprises a clip-type fastener, having a body (desirably made of resiliently deformable material) shaped so as to clip onto the catenary wire and securing means operable to inhibit removal of the body from the catenary wire when attached thereto.

The securing means preferably comprise an element, such as a stainless steel loop, attached to the fastener body by a hinge whereby the element can be rotated into and out of locking engagement with another portion of the fastener body, thereby enclosing the catenary wire within the fastener.

The second portion of the connection means desirably comprise a moulded cord-receiving body for receiving the dropper cord.

Preferably, a wedge and at least one socket are provided in the moulding of the catenary hook, or the cord-receiving body, for retaining the dropper cord therein.

The design of the wedge and the socket is such that, when they engage, the cord is securely gripped on as much of its circumference as possible to ensure that it does not slip.

Desirably, the wedge has an associated cross-pin for retaining it within the socket.

This pin slides in a cam profile and is bi-stable in one of two positions corresponding to when the cord length is being adjusted and when the cord is trapped between the wedge and socket. Advantageously, the cross-pin does not reach the end of its travel until a cord of the smallest available diameter is fully trapped between the wedge and the socket.

Preferably, a gap exists between the wedge and the socket when they are engaged.

The deliberate gap between the wedge and the socket allows water to drain past the cord and not be trapped in the moulding cavity, the aim being to discourage ice and possible damage by freezing.

Preferably, the connection means comprise a moulded body that is designed to disconnect the dropper from the catenary wire when the dropper cord is subjected to a second predetermined load.

Should the pantograph be operating at an abnormal height such that it hooks up on the dropper cord, the primary breakpoint (i.e. the load ring) is bypassed. In this case, the catenary hook, which has a designed-in breakpoint at the start of the hook feature, provides the second mode of failure. Specifically, the moulding of the catenary hook snaps, thus disconnecting it from the catenary wire. This allows the pantograph to pull the dropper away from the support structure without any further damage.

Desirably, the second predetermined load is a substantially vertically downwards force of at least 1800N.

In an embodiment of the present invention, the moulding of the catenary hook is designed to break at loads in excess of 1800 to 2000N.

Preferably, a protective member is provided on the dropper cord, the protective member being disposed on at least part of the length of the cord from one of its ends.

When in use, the dropper is suspended between a catenary wire and a conductor so that rainfall or airborne moisture may well wet the cord and form a conductive path. In an embodiment of the present invention, this is circumvented by providing a protective member that functions as an umbrella so that moisture is prevented from penetrating the cord or accumulating on at least some of its surface and is shed off the surface of the protective member. For example, in an embodiment of the present invention, the protective member is a silicone moulding or shed with a mushroom shape.

Desirably, the protective member is provided on ⅛^{th} the length of the dropper cord from one of its ends.

This positioning gives the extra advantage that the protective member acts as a mass damper for the first three modes of vibration as it would be an antinode of the 3^{rd} harmonic. This would reduce the amount of fatigue that the cord is subjected to and increases its lifetime.

Reference will now be made, by way of example, to the accompanying drawings, in which:

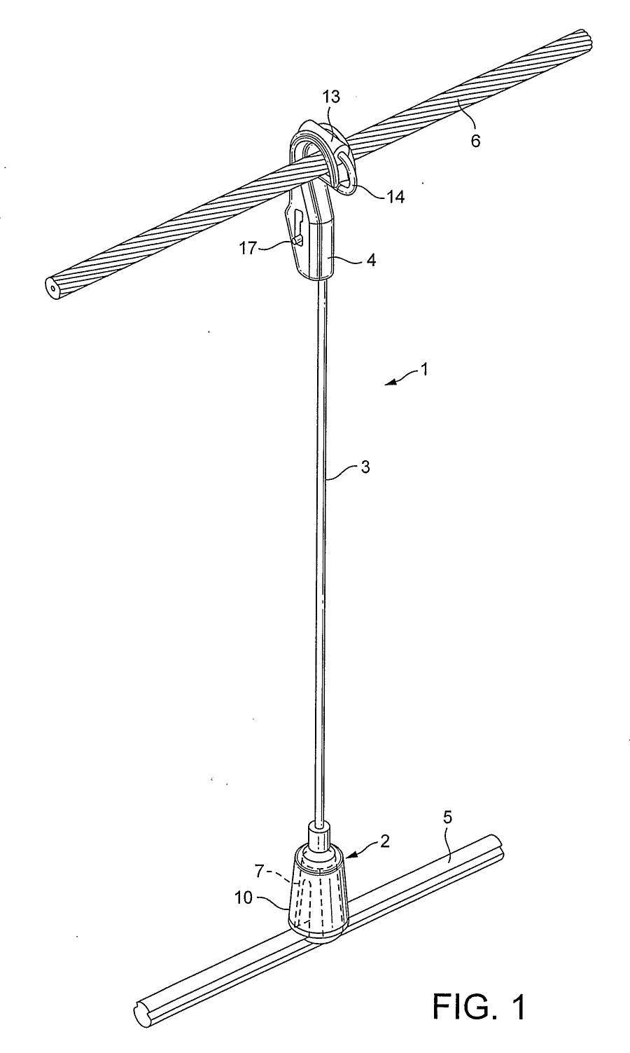

FIG. 1 shows a first dropper embodying the present invention when in use;

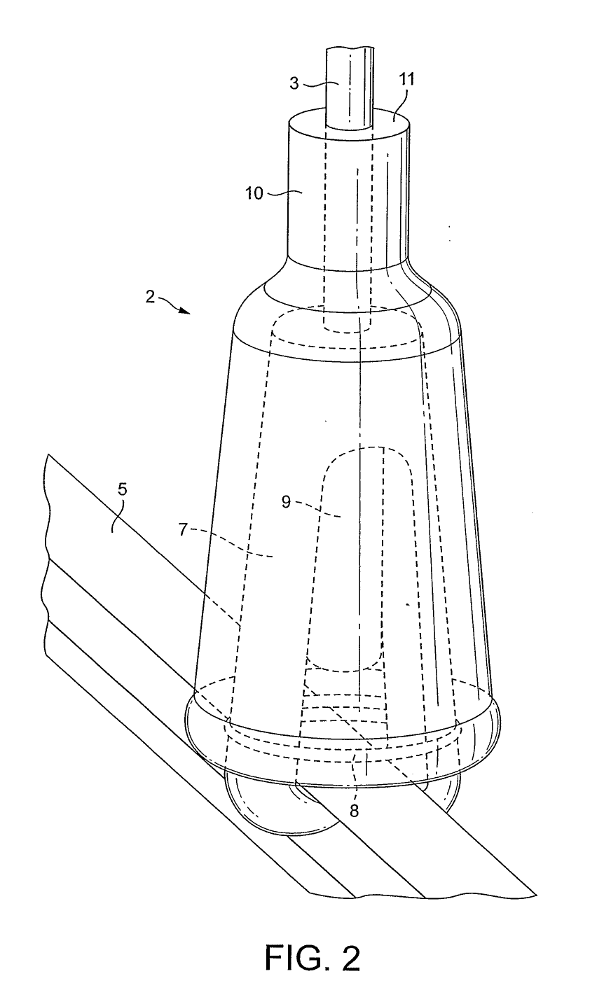

FIG. 2 shows a conductor clamp in an embodiment of the present invention;

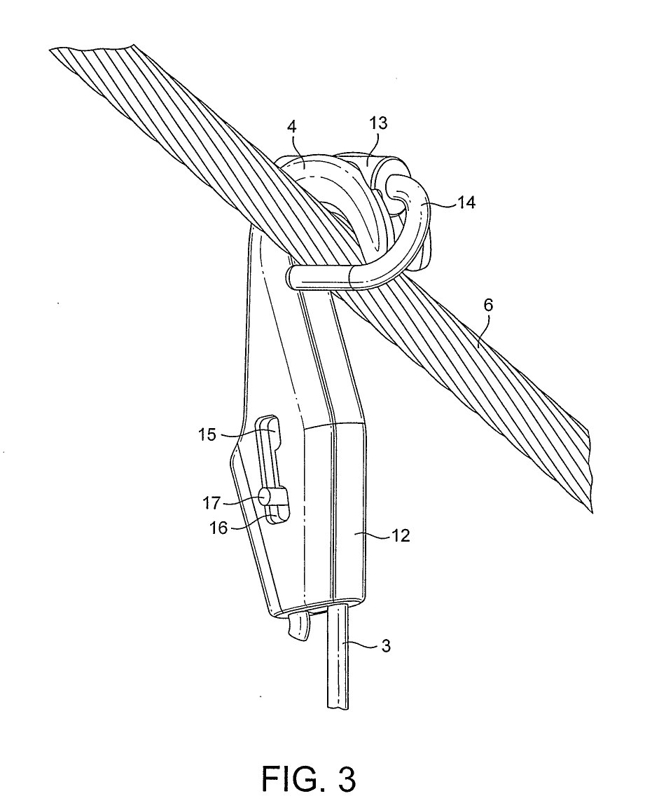

FIG. 3 shows a catenary hook in an embodiment of the present invention;

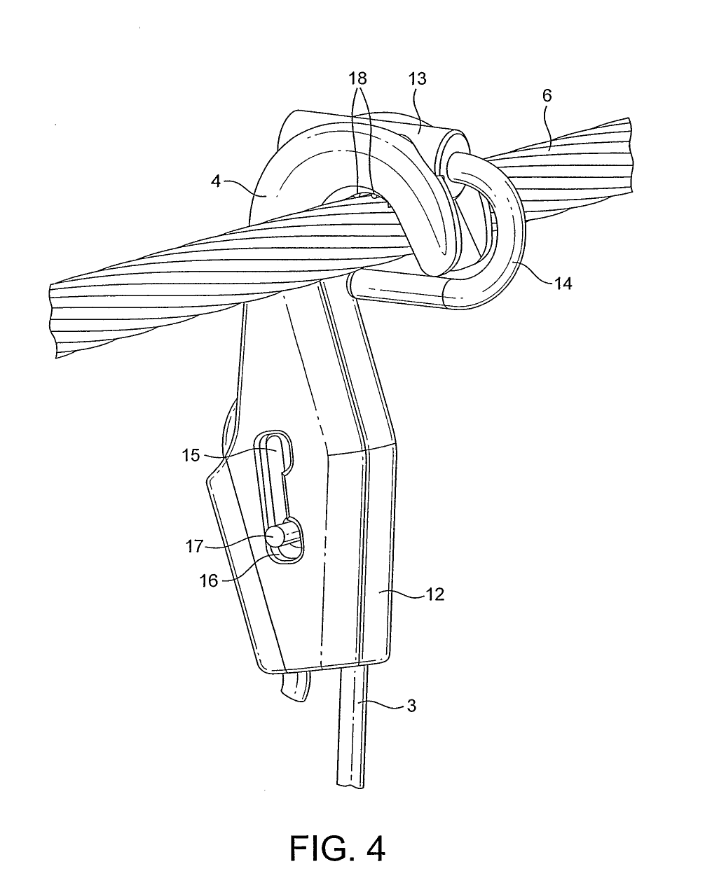

FIG. 4 shows more detail of the catenary hook shown in FIG. 3;

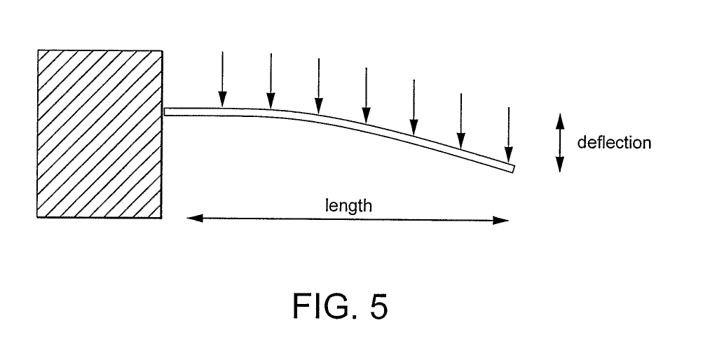

FIG. 5 illustrates how the flexibility of the dropper cord of the present invention and that used in GB 775,112 has been calculated; and

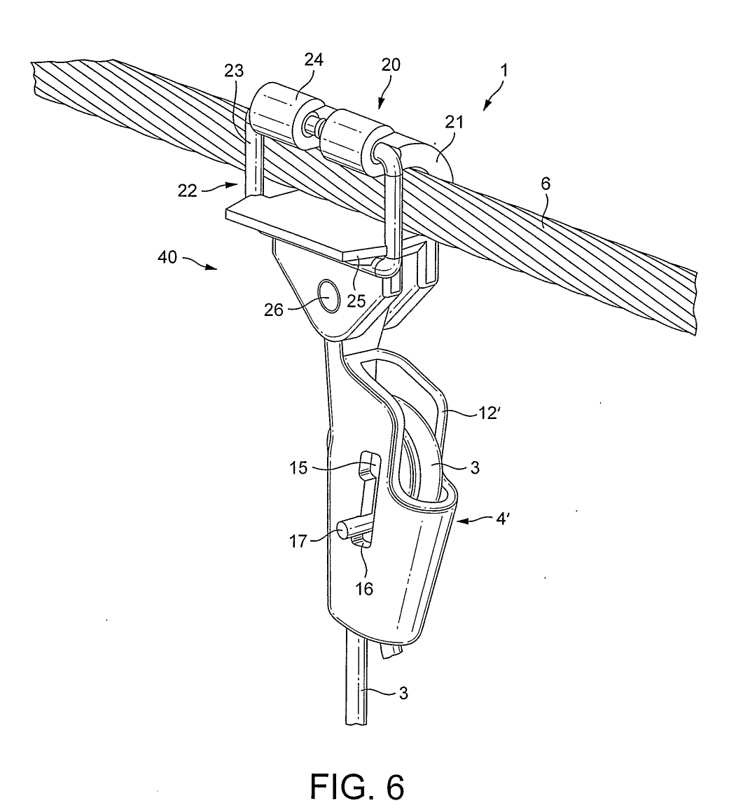

FIG. 6 shows a part of a second dropper embodying the present invention when in use.

As can be seen from FIG. 1, in this embodiment the dropper 1 consists of three main parts: the conductor clamp 2, the dropper cord 3 and the catenary hook 4. When in use, the dropper 1 connects via the conductor clamp 2 to the conductor 5, and via the catenary hook 4 to the overhead catenary wire 6. The main function of the dropper 1 is to support the conductor 5 at a fixed height (±10 mm) above the head of the rail. As discussed below, each of the constituents of the dropper 1 has been designed to enable this purpose.

FIG. 2 shows the conductor clamp 2 in more detail. Specifically, the conductor clamp 2 consists of a moulded clamp body 7 held together by a load ring 8. The conductor 5 has a cylindrical (rolled) profile, with axial grooves formed parallel to its axis, onto which the lower end of the clamp body 7 snaps. In order to further secure the connection with the conductor 5, jaws (not shown) are moulded into the conductor clamp 2 in the region where it snaps into contact with the conductor 5. The inner profile of the jaws is designed to correspond to the axial grooves in the conductor 5.

As most clearly seen from FIG. 2, the clamp body 7 is further provided with a continuous load ring 8 at its lower end where it connects with the conductor 5. The load ring 8 is accommodated in a groove (not shown) in the clamp body 7. When the dropper 1 is in use, the load of the conductor 5 is transferred to the dropper cord 3 via the clamp body 7. This would normally force open the clamp body 7 but is prevented by the load ring 8. If, however, due to environmental factors such as ice, wind or vegetation, the conductor 5 exerts an excessive vertical pull that approaches a maximum load that the clamp body 7 has been designed to withstand, the load ring 8 breaks first and releases the conductor 5, dropping it onto the track. In this way, the load ring 8 provides a first mode of damage control since the excessive vertical forces that the conductor clamp 2 is subjected to are not transferred to the catenary 6 and/or support structure. Furthermore, damage is limited to easily replaceable items both in terms of skill, manpower and costs. By contrast, known droppers transfer the excessive vertical pull of the conductor to the overhead catenary and support structure such that, ultimately, all of them are pulled down onto the track. Of course this is undesirable from the point of view that, not only does the line have to be closed for a significant period of time for repair work, but also that damage is not limited to isolated parts of the line, components of the dropper or indeed the traction system but involves all of them. By failing in cascade (i.e. by the load ring 8 breaking followed by the clamp body 7), the present invention makes it possible to limit damage to a localised section of the line. As the damage is remediable by simply replacing the damaged dropper, the problems associated with known droppers, such as line closure, damage and/or repair to the overhead traction system and secondary signalling equipment can be overcome.

Appropriate selection of the material and dimensions of the load ring allows the breaking load to be selected. In an embodiment of the present invention, the load ring 8 fails when the conductor clamp 2 is subjected to a maximum vertical force of 1200N. In this case, the load ring 8 is a hoop of 20 mm inner diameter, having a cross-sectional diameter of 0.8 to 1.0 mm. A burst strength of approximately 80% has been allowed for the weld. The burst strength depends on the angles and friction parameters at the clamping surface.

The conductor clamp 2 further comprises an aluminium ferrule 9, which terminates the dropper cord 3. The dropper cord 3 is threaded via a dole 11 in the upper end of the conductor clamp 2 into the ferrule 9 wherein it is looped and held compactly. Since the ferrule 9 has a larger diameter than the hole 11, any upload on the cord 3 will cause the ferrule 9 to abut the lower face of the hole 11, thereby allowing a load to be applied to the inside of the clamp body 2.

A protective elastomer sleeve 10 is provided over the conductor clamp 2 and the load ring 8. It protects them from adverse environmental conditions such as rain, snow, contamination, etc., thus increasing their life expectancy and resilience. Importantly, the sleeve 10 inhibits the ingress of water, which may cause galvanic corrosion between the ferrule 9 and the copper conductor 5 or load ring 8. For ease of fitting, the sleeve 10 is designed to snap over the outer profile of the clamp body 7 and the load ring 8.

Additionally, the elastomer can be provided as a tight-fitting continuous sleeve 10 or impregnated onto the surface of the dropper cord 3 whilst ensuring that there are no voids in order to deter moisture ingress into the cord 3.

In an embodiment of the present invention, the sleeve 10 is made of silicone but can be made of any other suitable material.

As can be seen in FIG. 1, the dropper cord 3 spans between the conductor 5 and the catenary 6. It has been developed with certain design parameters in order to ensure that the conductor 5 can be held in the correct position over many years without suffering major degradation. Some of these parameters dictate that the cord 3: (i) is resistant to UV attack; (ii) is tolerant to environmental pollutants; (iii) is tolerant to nitric acid contamination created by electrical discharges in polluted air; (iv) suffers little or no creep under load with time; (v) does not absorb water and/or become conductive; (vi) is wound in such a manner that loading does not cause any untwisting and, therefore, change of cord length; (vii) has excellent fatigue properties; (viii) has a smooth exterior so as to shed contamination; (ix) is extremely flexible; (x) has a low mass; and (xi) has a small profile area to lessen wind loading. After diligently testing a large number of materials, the present inventors have found that poly ether ether ketone (PEEK™Victrex Corporation) or a liquid crystal polymer such as Vectran™ (Celanese Advanced Materials Inc.) satisfy the above requirements. Most importantly though, these materials give the dropper cord 3 the flexibility that distinguishes the present invention from other known droppers.

For example, GB 775112 discloses a dropper comprising a length of inorganic fibre rope that is coated and impregnated with a water-repellant, insulating medium and that is looped at either end. One of the loops is supported by a saddle, which clips onto a catenary wire, whereas the other one is fitted with a standard contact wire clip. Although it is purported that the rope is flexible, simple empirical calculations show that this is not the case.

Referring to FIG. 5, the flexibility of the GB 775112 rope has been quantified by assuming that a length of this rope is mounted at one end and allowed to sag under its own weight at the other end. The deflection at the free end is a measure of the flexibility of the rope. The results of this calculation for a 100 mm length of the GB 775112 rope, and the same length of PEEK™ and Vectran™ cord in an embodiment of the present invention, are presented in Table 1. Other details on the makeup of the rope and cords have also been given in Table 1 for the sake of completeness.

TABLE 1

| Parameter (units) | GB 775112 | Vectran | PEEK |
|---|---|---|---|
| Filament diameter (mm) | 0.794 | 0.023 | 0.250 |
| Filament number/cord | 8 | 4200 | 19 |
| No. of cords in rope | 20 | 3 | 7 |
| Material | Glass | Vectran | PEEK |
| Cord diameter inc. sheath (mm) | 12.7 | 3.8 | 3.8 |
| Cord area (mm²) | 79.17 | 5.23 | 6.53 |
| Density (g/cm³) | 2.7 | 1.49 | 1.55 |
| Mass/unit length (g/mm) | 0.213767 | 0.007800 | 0.010119 |
| Second moment of area (mm⁴) | 200.74 | 5.38 | 5.38 |
| Flexural modulus (Gpa) | 73 | 3.6 | 9.7 |
| Deflection for 100 mm length | 0.912 | 25.183 | 12.125 |
| (mm) | | | |

It can be seen from Table 1 that the deflection of the GB 775112 rope is only 0.912 mm. When put into the context of how the rope would perform when subjected to the vertical forces exerted by the passage of a pantograph along the conductor length which cause upward displacement of the conductor by ±10 mm, it is evident that this rope is rigid and would probably transfer the vertical displacement to the catenary. As discussed earlier, this would produce a standing wave ahead of the pantograph, which has several undesirable effects. In contrast, the cords made of PEEK™ and Vectran™ deflect by 12.125 mm and 25.183 mm, respectively, i.e. for the same length, they are more than 10 times flexible than the GB 775112 rope and would, therefore, not suffer from the same setbacks. Furthermore, the results of Table 1 show that, for a 100 mm cord length, the PEEK™ and Vectran™ cords bend by more than 10% of their length, i.e. they bend by more than 10 mm and would, therefore, comfortably absorb the 10 mm uplift typically imparted to the conductor by the passage of a pantograph by bending.

It should also be noted that GB 775112 cannot be seen to solve the same problems as present invention since it neither discloses nor suggests that the inorganic rope has been used to increase the flexibility of the dropper disclosed therein. Rather, this document only highlights the water repellent, insulating properties of the rope, which have been imparted to it by coating/impregnating it with an appropriate medium.

Furthermore, a test on the PEEK™ and Vectran™ cord used in an embodiment of the present invention, where a 23 kg mass has been lifted by a fixed distance and then lowered again such that the cord is completely unloaded, has shown that the cords did not fail after 11 million cycles, i.e. the PEEK™ and Vectran™ cords are highly durable.

FIG. 3 shows a catenary hook 4 in an embodiment of the present invention. Its function is to attach the dropper cord 3 to the support (catenary) wire 6 in a controlled position and orientation.

Catenary wires can vary but are normally 10.7 mm twisted copper multifilaments (1 core, 6 inner and 12 outer filaments). The body of the catenary hook 4 has been designed to fit over a wide range of catenary wire diameters, including the largest which is up to 14 mm in diameter.

A bearing cylinder 13 is moulded in the top of the catenary hook 4 with its axis lying perpendicular to the dropper cord 3 and catenary wire 6. A wire hook 14 is housed in the bearing cylinder 13 with dimensions that are chosen such that the underside of the catenary wire 6 is held firmly against the inside of the hook moulding. Thus, the probability of the catenary wire 6 twisting is reduced. Even if the wire 6 were to twist, it would still be held relatively securely within the catenary hook 4 since the wire hook 14 would “twist” with it. This is attributed to the fact that the wire hook 14 has a rolled profile within its bearing section, which snaps over a moulded feature in the bearing cylinder 13, thus allowing rotation of the wire hook 14 whilst being retained in the moulding.

As most clearly seen from FIG. 4, a series of spikes 18 are moulded on the inner surface of the catenary hook 4. They are designed to fit into the interstices of the 12 outer wire filaments of the catenary wire 6 forming a helical path along the length of the catenary wire 6. If the catenary wire 6 twisted excessively, the hook 4 would not simply twist with it (as described above) but would rotate relative to the axis of the wire 6 and travel down the helical path along its length. Attachment of the hook 4 to the catenary wire 6 via the spikes 18 in conjunction with the pull of gravity on the hook body via the dropper cord 3 inhibits such rotation of the catenary hook 4.

As shown in FIG. 3, the dropper cord 3 is inserted into the bottom of the body 12 of the catenary hook 4, passed over a floating wedge 15 that is movable between upper and lower positions, and exits the hook 4 through the same opening. The entry leg is axially aligned with the centre of the hook 4 in order to ensure that, when loaded, there is no twisting of the hook 4 from its vertical position. The wedge 15 is moved to the upper position when the cord length is being adjusted so that the cord 3 can be passed through the hook 4 to the desired extent and correct position. When a load is applied to the cord 3, for example when the dropper 1 is connected with the conductor 5, the wedge 15 moves to the lower position into a socket 16 moulded in the hook body 12 and traps the cord 3 therein. The inside profiles of the wedge 15 and the socket 16 are such that, when they engage, the cord 3 is gripped on as much of its circumference as possible to ensure that it does not slip. The higher the load, the tighter the wedging action. It is possible that the loose tail of the cord 3 may be cut and a quality seal or ferrule applied to the end, designating the installation date and also further preventing the tail from slipping through the wedge 15 and socket 16. There is a deliberate gap between the wedge 15 and the socket 16 in order to allow water to drain past the cord 3 and not be trapped in the moulding cavity. In this way, the build-up of ice and possible damage by freezing is avoided.

The wedge 15 is retained in the socket 16 by a cross-pin 17. This pin 17 slides in a cam profile and is bi-stable in one of two positions corresponding to when the cord length is being adjusted and when the cord is trapped between the wedge 15 and socket 16. The cross-pin 17 does not reach the end of its travel until a cord 3 of the smallest available diameter is fully trapped between the wedge 15 and the socket 16, thus ensuring maximum wedging action.

Since the length of the cord 3 between the conductor 5 and catenary wire 6 can be adjusted by simply pulling the loose tail in one of two directions before the wedging action, the dropper 1 can be fitted between conductors and catenary wires of varying span onsite, with ease, and without requiring specialised measurement or data storage equipment or skill, which as discussed earlier is not possible with known droppers. For example, a dropper embodying the present invention can be supplied in three standard lengths, and installed simply by hanging the dropper on the catenary, fitting the conductor wire and then adjusting the height of the dropper to a datum level using known methods, e.g. physical, laser, etc.

A further advantage of the dropper 1 is that it provides a second mode of damage control. Should the pantograph be operating at an abnormal height such that it hooks up on the dropper cord 3, the primary breakpoint (i.e. the load ring 8) is bypassed. In this case, the catenary hook 4, which has a designed-in breakpoint at the start of the hook feature, provides the second mode of failure. Specifically, the moulding of the catenary hook 4 snaps, thus disconnecting it from the catenary wire 6. This allows the pantograph to pull the dropper away from the support structure without any further damage. In contrast, the current design of semi-rigid stainless steel droppers cause significant damage to the support structure and closure of the affected line for significant periods of time. In an embodiment of the present invention, the moulding of the catenary hook 4 is designed to break at loads in excess of 1800 to 2000N applied to the dropper cord 3.

Another advantage of the dropper 1 is that it has been designed to be less than one friable material means that it causes less damage to pantographs, which are made of graphite blocks and therefore very brittle and fragile. Because the dropper 1 is light, it is simply punched out of the way when hit by a pantograph with excess force and since it is friable, the energy of the impact is dissipated in breaking the dropper 1 rather than the pantograph. In contrast, the weight and the lack of pliability of the currently-used metallic droppers have been known to cause irreparable damage to the pantographs.

A further advantage of the dropper 1 is highlighted by considering that the conductor 5 is supplied with power via bonding cables at intervals along the railway track. These are twisted copper, flexible cables bonded to the catenary 6 and the conductor 5. During the passage of a train, the pantograph draws down power and the conductor 5 is re-supplied by straddling bonding cables. Due to the distance of the pantograph from these bonding cables and the internal resistance of the overhead system, the current varies significantly through these cables. The stainless steel droppers that are currently used are conductive and stray currents are passed through the droppers. This causes discharges and arcing at the ends of the stainless wire leading to failure and corrosion damage. By contrast, the dropper 1 eliminates these stray currents and the supply can be controlled totally by the bonding cables.

Finally, a further advantage of the dropper 1 is highlighted by considering that, when in use, the dropper 1 is suspended between the catenary wire 6 and the conductor 5, and that rainfall or airborne moisture may well wet the cord 3 and form a conductive path. In an embodiment of the present invention, this is circumvented by providing a silicone moulding/shed to grip the cord 3 and function as an umbrella so that moisture is prevented from penetrating the cord 3 or accumulating on at least some of its surface and is shed off the silicone moulding. For example, the silicone moulding may be mushroom-shaped and mounted closer to one of the ends of the cord 3, the moulding having a bore that fits tightly onto the cord 3. In an embodiment of the present invention, the silicone moulding is mounted at ⅛^{th} the length of the cord 3 from one of its ends. This positioning gives the extra advantage that the moulding acts as a mass damper for the first three modes of vibration as it would be an antinode of the 3^{rd} harmonic. This would reduce the amount of fatigue that the cord 3 is subjected to and increases its lifetime.

Part of a second dropper 1′ embodying the present invention is shown in FIG. 6. This form of dropper is intended to be fitted by means of a long insulated pole from the ground whilst the conductor is “live”. Although not shown in FIG. 6, the second dropper 1′ may have the same form of conductor clamp 2 as discussed above. In the dropper 1′ of FIG. 6 the catenary hook 4 is replaced by another form of connection means 40 comprising a first portion 20 for attaching the dropper 1′ to the catenary wire 6 and a second portion 4′, joined to the first portion 20 by means of a stainless steel pin 26, for holding the dropper cord 3. The plastic moulding at the joint is designed to break (predictably) at high load. The first portion 20 comprises a clip-type fastener having a resiliently-deformable body 21 shaped so as to clip onto the catenary wire 6 and securing means (22) comprising a stainless steel loop 23 attached to the fastener body 21 by a hinge 24, whereby the loop 23 can be rotated into and out of locking engagement with a portion 25 of the fastener body 21 so as to enclose the catenary wire 6 within the fastener 20. The second portion 4′ of the connection means 40 is very similar in design to the catenary hook 4 described above, except in that it does not have bearing cylinder 13 and hook 14, and reference numerals 15 to 17 designate the same elements in FIG. 6 as they do in FIGS. 3 and 4. The moulded cord-receiving body 12′ of dropper 1′ is similar in design to the body 12 of the catenary hook 4 of FIGS. 3 and 4, except in that the top part is open to reveal the wedge 15 and dropper cord 3.

It will be understood that the present invention has been described above purely by way of example, and modifications of detail can be made within the scope of the invention. For example, the load bearing element may be formed to be part of the clamp body 7 and not as a separate member (as is the case for the load ring 8). Furthermore, it would be clear to the skilled person consulting the specification that the scope of the present invention is not limited to PEEK™ and Vectran™ but includes any other appropriate material that has the same, similar or greater flexibility than these materials.

We claim:

1. A dropper for use in connecting a conductor and a catenary wire in an overhead electric traction system comprising:
a conductor clamp for connecting the dropper to the conductor, which comprises a molded clamp body that snaps onto the conductor;
a dropper cord connected to the clamp body an end opposite to that connecting with the conductor; and
connection means for connecting the dropper to the catenary wire, the connection means comprising a first portion for attaching the dropper to the catenary wire and a second portion, joined to the first portion, for holding the dropper cord, the first portion of the connection means comprising a clip-type fastener having a body shaped so as to clip onto the catenary wire and securing means operable to inhibit removal of the body from the catenary wire when attached thereto;
the dropper cord being flexible such that the application of a substantially vertically upwards force exerted by the conductor to the conductor end of the dropper cord causes the dropper cord to bend, thereby preventing any upwards movement of the catenary wire;
the dropper cord being made of material which is not electrically conductive; and
the securing means comprising an element attached to the fastener body by a hinge whereby the element can be rotated into and out of locking engagement with another portion of the fastener body, thereby enclosing the catenary wire within the fastener.

2. A dropper as claimed in claim 1, wherein the dropper cord bends by at least 10% of its length.

3. A dropper as claimed in claim 1, wherein the dropper cord is made of poly ether ether ketone (PEEK™).

4. A dropper as claimed in claim 1, wherein the dropper cord is made of liquid crystal polymer.

5. A dropper as claimed in claim 4, wherein the liquid crystal polymer is Vectran™.

6. A dropper as claimed in claim 1, wherein the clamp body further comprises jaws on the interior of its section that snaps onto the conductor.

7. A dropper as claimed in claim 1, wherein a load bearing elements is provided on the outer body of the conductor clamp.

8. A dropper as claimed in claim 7, wherein the load bearing element is designed to fail when the conductor clamp is subjected to a first predetermined load.

9. A dropper as claimed in claim 8, wherein the first predetermined load is a substantially vertically downwards force of at least 1200N.

10. A dropper as claimed claim 7, wherein the load bearing element is made of stainless steel.

11. A dropper as claimed in claim 7, wherein the load bearing element is a load ring provided on a groove formed on the outer body of the conductor clamp.

12. A dropper as claimed in claim 1, wherein the conductor clamp further comprises a ferrule for containing the dropper cord.

13. A dropper as claimed in claim 12, wherein the ferrule is made of aluminum.

14. A dropper as claimed in claim 1, wherein an elastomeric sleeve is provided over the conductor clamp and the load bearing element.

15. A dropper as claimed in claim 14, wherein the elastomeric sleeve is also provided over the dropper cord.

16. A dropper as claimed in claim 14, wherein the sleeve is made of silicone.

17. A dropper as claimed in claim 1, wherein the connection means comprise a catenary hook for connecting the dropper cord to the catenary wire.

18. A dropper as claimed in claim 17, wherein the catenary hook is provided with at least one spike on its inner surface.

19. A dropper as claimed in claim 17, wherein a wire hook is contained in a bearing cylinder molded in the top of the catenary hook.

20-23. (canceled)

24. A dropper as claimed in claim 1, wherein the element comprises a stainless steel loop and the fastener body is made of a resiliently deformable material.

25. A dropper as claimed in claim 1, wherein the first portion is joined to the second portion by means of a stainless steel pin.

26. A dropper as claimed in 1, wherein the second portion of the connection means comprises a molded cord-receiving body for receiving the dropper cord.

27. A dropper as claimed in claim 17, wherein a wedge and at least one socket are provided in the molding of the catenary hook, or the cord-receiving body, as the case may be, for retaining the dropper cord therein.

28. A dropper as claimed in claim 27, wherein the wedge and socket are engaged once the dropper is subjected to a load.

29. A dropper as claimed in claim 27, wherein the wedge has an associated cross-pin for retaining it within the socket.

30. A dropper as claimed in claim 27, wherein a gap exists between the wedge and the socket when they are engaged.

31. A dropper as claimed in claim 1, wherein the connection means comprise a molded body that is designed to disconnect the dropper from the catenary wire when the dropper cord is subjected to a second predetermined load.

32. A dropper as claimed in claim 31, wherein the second predetermined load is a substantially vertically downwards force of at least 1800N.

33. A dropper as claimed in claim 1, wherein a protective member is provided on the dropper cord, the protective member being disposed on at least part of the length of the cord from one of its ends.

34. A dropper as claimed in claim 33, wherein the protective member is one of a silicone molding or shed.

35. A dropper as claimed in claim 33, wherein the protective member is provided on ⅛^{th} the length of the dropper cord from one of its ends.

36. A dropper for use in connecting a conductor and a catenary wire in an overhead electric traction system comprising:
a conductor clamp for connecting the dropper to the conductor, which comprises a molded clamp body that snaps onto the conductor;
a dropper cord connected to the clamp body at the end opposite to that connecting with the conductor;
connection means for connecting the dropper to the catenary wire; and wherein
a load bearing element is provided on the outer body of the conductor clamp, the load bearing element being designed to fail when the conductor clamp is subjected to a predetermined load.

37. A dropper as claimed in claim 36, wherein the predetermined load that causes failure of the load bearing element is a substantially vertically downwards force of at least 1200N.

38. A dropper as claimed in claim 36, wherein the load bearing element is made of stainless steel.

39. A dropper as claimed in claim 36, wherein the load bearing element is a load ring provided on a groove formed on the outer body of the conductor clamp.

40. A dropper for use in connecting a conductor and a catenary wire in an overhead electric traction system comprising:
a conductor clamp for connecting the dropper to the conductor, which comprises a molded clamp body that snaps onto the conductor;
a dropper cord connected to the clamp body at the end opposite to that connecting with the conductor; and
connection means joined to the dropper for connecting the dropper cord to the catenary wire; wherein the connection means; comprise a molded body designed to disconnect the dropper from the catenary wire when the dropper cord is subjected to a predetermined load.

41. A dropper as claimed in claim 40, wherein the predetermined load that acts on the dropper cord to cause disconnection of the connection means from the catenary wire is a substantially vertically downwards force of at least 1800N.
